(19) United States
(12) Patent Application Publication
(10) Pub. No.: US 2011/0092222 A1
(43) Pub. Date: Apr. 21, 2011

(54) VECTORING SERVICE INITIATION SYSTEM AND METHOD BASED ON SENSOR ASSISTED POSITIONING

(75) Inventors: LUN-CHIA KUO, Taichung City (TW); Yi-Hsiung Huang, Tainan County (TW); Sheng-An Chang, Pingtung County (TW); Yu-Hung Hsueh, Kaohsiung County (TW); Chun-Ta Chen, Taoyuan County (TW)

(73) Assignee: Industrial Technology Research Institute, Hsinchu (TW)

(21) Appl. No.: 12/902,554

(22) Filed: Oct. 12, 2010

(30) Foreign Application Priority Data
Oct. 20, 2009 (TW) 098135358

(51) Int. Cl. H04W 64/00

(52) U.S. Cl. 455/456.1

(57) ABSTRACT

A system and a method for vectoring service initiation, such service initiation can be data transfer, game initiation, media download, media streaming initiation, house application and the like, based on sensor assisted positioning are provided, which employ location sensors built in hand-held devices with positioning technology to provide an instinctive 2-D or 3-D user-machine interface, by that the user is able to transfer a file from a source device to a target device.

### 1. TECHNICAL FIELD

The disclosure generally relates to a system and a method for vectoring service initiation based on sensor assisted positioning and, more particularly, to a system and a method using location sensors built in devices with positioning technology to provide an instinctive user-machine interface for facilitating an user to invoke service initiation from a source device to a target device.

### 2. TECHNICAL BACKGROUND

In recent years, the portable hand-held devices have become more and more important in the daily life, and a variety of hand-held devices have become more powerful when it comes to the dealing with tasks such as retrieving/sending emails, accessing RSS or even playing multi-media contents. The things that were dealt with on personal computers are now dealt with on portable hand-held devices because the hand-held devices are becoming more sophisticated and equipped with more sensors for the user. For example, for the hand-held devices, such as Apple iPhone, HTC Touch Diamond, and the like, users are able to operate these smart devices intuitively and easily through a variety of touch-base interfaces that are provided thereon.

There were plenty of examples of improved user-machine interfaces that shook the market. Apple introduced touch pads on MacBooks (notebook computers) to replace the mouse long before iPhone was launched. Such a special and friendly user-machine interface attracted a large amount of fans of MacBooks. Moreover, iPhone uses multi-touch control so that the user can use the device by the drag and zoom operations and the embedded auto-rotate and smart sensor functions without using the touch pen. In addition, the Wii console launched by Nintendo at 2006 uses wireless control to replace the button interfaces on conventional gaming machines. Such an innovative user-machine interface adapted on Wii evoked a positive response to Nintendo by getting ahead of SONY's Play Station series in gaming machine sales.

The user-machine interface is based on the so-called “human technology”, which makes the user-machine interface less complex and user-friendly to win a passionate response from the user and is suitable not only for the hand-set devices, but also for other IT products.

Nevertheless, the currently available user-machine interfaces such as touch panels and sensors are used on single machines. For example, the touch interfaces on iPhone and the wireless sensors on Wii are used on single machines. As the portable hand-held devices are becoming more and more powerful to deal with the tasks that are dealt with on personal computers, some user-machine interfaces have been developed for retrieving/sending emails, accessing RSS or even playing multi-media contents. However, there is still no user-friendly user-machine interface for service initiation between modern hardware platforms.

This disclosure provides a system and a method for vectoring service initiation based on sensor assisted positioning, using the location sensors built in hand-held devices with positioning technology to provide an instinctive 2-D or 3-D user-machine interface so that the user is able to invoke service initiation from a source device to a target device.

### SUMMARY

This disclosure provides a system and a method for vectoring service initiation based on sensor assisted positioning, using sensor assisted positioning technology to provide an instinctive user-machine interface so that the user is able to invoke service initiation, such as data transfer, game initiation, media download/media streaming initiation, house application and the like, from a source device to a target device.

### BRIEF DESCRIPTION OF THE DRAWINGS

The embodiments of this disclosure will be readily understood by the accompanying drawings and detailed descriptions, wherein:

FIGS. 1A to 1C are flowcharts of a method for service initiation in this disclosure;

FIG. 2 is a flowchart of a proxy server for uploading positioning information in this disclosure;

FIG. 3 is a system structure of a particle filtering positioning system in one embodiment of this disclosure;

FIG. 4 shows motion positioning using a particle filtering positioning system in one embodiment of this disclosure;

FIG. 5 shows motion information transfer using a motion converter in one embodiment of this disclosure;

FIG. 6 shows calculation of motion coordinates of a user using a particle filtering positioning system in one embodiment of this disclosure;

FIG. 7 shows an XML format data for uploading information to a proxy server in one embodiment of this disclosure;

FIG. 8 shows data for storing information in a database in one embodiment of this disclosure;

FIG. 9 shows a flowchart for issuing a service initiation request from a source device to a proxy server in one embodiment of this disclosure;

FIG. 10A-10D show an XML format data for sending information from a proxy server to a source device in one embodiment of this disclosure;

FIG. 11 shows an XML format data for converting global map information to GUI-domain map information in one embodiment of this disclosure;

FIG. 12 is a schematic diagram for file transfer to a target device in a GUI domain in one embodiment of this disclosure;

FIG. 13 shows a flowchart for transferring data and protocols between a target device and a source device in one embodiment of this disclosure; and

FIG. 14 shows the contents of data and protocols transferred between a target device and a source device in one embodiment of this disclosure.

### DETAILED DESCRIPTION OF EMBODIMENTS

This disclosure can be exemplified but not limited by various embodiments as described hereinafter.

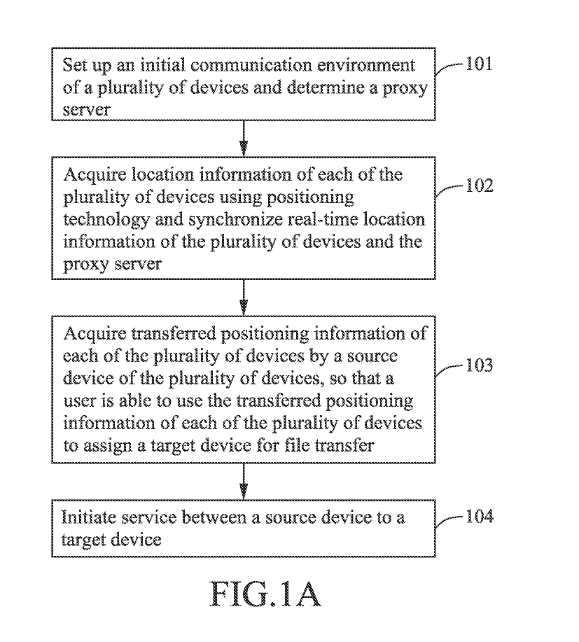

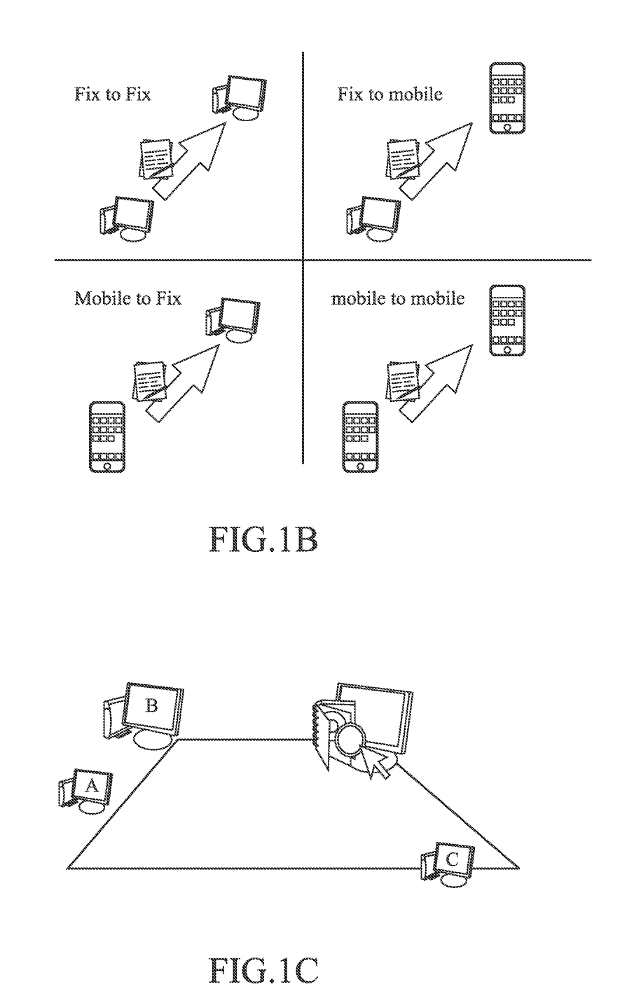

Please refer to FIG. 1, which is a flowchart of a method for service initiation in this disclosure. In FIG. 1, the method for vectoring service initiation based on sensor assisted positioning comprises steps herein, and such service initiation can be data transfer, game initiation, media download, media streaming initiation, house application and the like.

In step 101, an initial communication environment of a plurality of devices is set up and a proxy server is determined.

In step 102, the devices acquire the location information of each of the plurality of devices using positioning technology and synchronize real-time location information of the plurality of devices and the proxy server.

In step 103, a source device of the plurality of devices acquires transferred positioning information of each of the plurality of devices so that a user is able to use the transferred positioning information of each of the plurality of devices to assign a target device for service initiation.

In step 104, initiate service between a source device and a target device.

The flowchart in FIG. 1 is described in detailed herein. In step 101 for setting up the initial environment, wireless networks (such as WiFi, WiMAX, GSM, etc) are initialized to achieve communicating with a proxy server or the like. Moreover, for positioning, triangulation systems and pattern-matching positioning systems and sensor feedback elements for GPS (global positioning system) or wireless networks are required. The sensor feedback elements are capable of sensing the currently moving inertial trajectory and behaviors and sending them back to the positioning system. Moreover, the devices are provided with protocols (such as MSN, HTTP, P2P, etc) for file transfer and settings (such as username, password, IP, etc) for the protocols so that the devices are capable of transferring files. If the devices are disposed indoors and the positioning technology is based on particle filtering algorithm and sensor assisted seamless hybrid positioning system, information of map and topography of a building are required. In one embodiment of this disclosure, when the plurality of devices are a source device and a target device without using any proxy server arranged therebetween, one of the source device and the target device can be used as a proxy server. Otherwise, a fixedly disposed device (such as a WiFi access point) in a LAN or a far-end communication device (such as a base station) can be used as a proxy server to acquire transferred positioning information to between the source device and the proxy server to generate a global map for the source device to transfer a file to the target device.

However, when the system needs the proxy server and no such proxy server exists, either said source device or said target device can be a proxy server being capable of real-time receiving and transferring real-time location information of each of said devices.

It is noted that the proxy server provides information of map and topography of a building if the plurality of devices are disposed indoors and particle filtering algorithm and sensor assisted seamless hybrid positioning are used, and the initial communication environment of the plurality of devices provide: wireless networking based on WiFi, WiMAX or GSM so as communicate with the proxy server or the other devices; a global positioning system or a wireless triangulation positioning and pattern-matching positioning system and a sensor feedback element capable of sensing current inertial trajectories and behaviors and transmitting the current inertial trajectories and behaviors to the positioning system; and protocols for MSN, HTTP and P2P and settings for the protocols, the settings comprising usernames, passwords and IP's so that the plurality of devices are capable of transferring files.

Various devices employing the present disclosure for service initiation are illustrating in the following circumstances. As shown in FIG. 1B, the device used for vector service initiation can either be a fix device, such as digital TV, digital photo frame, home PC or electronic board, or be a mobile device like cellular phone, notebook computer or digital camera. So, the service initiation between said devices will be one of the following combinations, that is, fix to fix, fix to mobile, mobile to fix or mobile to mobile, each schematic diagram is showing in respective section in FIG. 1B.

In one embodiment of service initiation between fix device and fix device, the user can transfer data from a home PC to a digital TV by “pointing” the file from the PC to the TV thru gesture operation. And in the example illustrating the service initiation from fix device to a mobile device, the user is able to transfer the supermarket DM coupon showing in an electronic advertisement board to the user's cellular phone thru gesture operation.

The step 102 for acquiring the location information of each of the plurality of devices using positioning technology and synchronizing real-time location information of the plurality of devices and the proxy server further comprises steps herein.

In the system employing the vector service initiation technology of the present disclosure, one embodiment shows the user is able to use “drag and drop” of gesture operation to move a file to a target device and the “preview” function of the target device will display the information of the file, such as file name, file type and file size for user's preview, the schematic diagram is shown in Step 1 of FIG. 1C. After that, when the gesture operation completed and the user's finger is released from the screen, the file is therefore transferred to the target device, which is shown in Step 2 of FIG. 1C. In step 201, a plurality of devices acquires the location information of each of the plurality of devices using positioning technology.

In step 202: the location information in an XML format of the plurality of devices is uploaded to the proxy server at designated time.

In step 203, the proxy server integrates the location information of the plurality of devices into a global map.

More particularly, in step 201, location information can be acquired by any positioning technology, capable of acquiring positioning information, such as GPS (global positioning system) or WiFi positioning. The proxy server stores the location information of each of the devices so that it can assist the user to assign a target device for file transfer.

The embodiment using particle filtering algorithm and sensor assisted seamless hybrid positioning system is described herein.

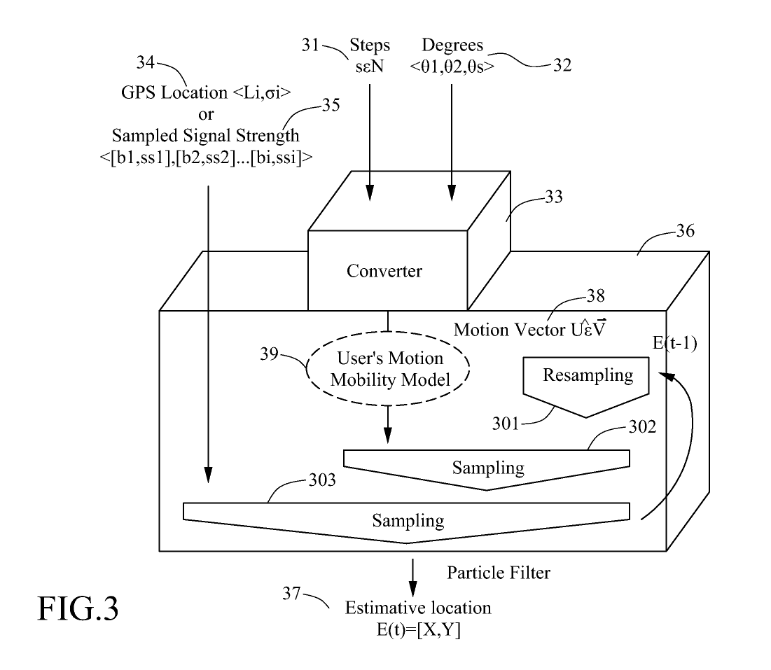

Please refer to FIG. 3, which a system structure of a particle filtering positioning system in one embodiment of this disclosure. The system structure comprises input data, a data converter and a positioning method. The input data can be categorized into two parts. Firstly, the data detected by the sensors can be processed and modulated in advance so as to be integrated with conventional positioning systems. By use of a pedometer or a compass on the user, real-time motion information, accumulative counts of steps of the user (as denoted by 31 in FIG. 3) and the angle shown on the compass can be acquired and processed by a converter (as denoted by 33 in FIG. 3) to output a total motion vector within a positioning range. Secondly, the matching samples of wireless signals such as the matching of GPS coordinates (Lᵢ) and errors (σᵢ) (as denoted by 34 in FIG. 3) and the matching of wireless signal strength (SSᵢ) and wireless access points (bᵢ) (as denoted by 35 in FIG. 3) are integrated by internal positioning algorithm with the motion vector generated by the converter 33 so that the current position of the user can be precisely evaluated. The positioning algorithm can be particle filtering algorithm (as denoted by 36 in FIG. 3). Estimated location E(t)=[X,Y] 37 can thus be calculated.

The particle filtering algorithm 36 can be exemplified by sampling history information in a continuous space to select a couple of sample spaces as location sets of the user. One of the sample spaces is then sifted as an optimal location according to the detected data.

Equation (1) describes a mathematical expression of particle filtering algorithm, which indicates the probability that a state Xₜ takes place at T=k under a series of observations Z_{1:k} (from t=1 to k).

Bel(xₜ)=p(xₖ|z_{1:k})∞p(zₖ|xₖ)∫p(xₖ|xₖ₋₁)p(xₖ₋₁|z_{1:k})dxₖ₋₁ (1)

If such a mathematical expression is implemented as positioning, each estimated positioning result is denoted as N samples then a prediction module is used to determine a possible one from the N samples using Equation (2) to continuously calculate the weight of each sample. A next positioning result can be acquired by re-sampling according to the distribution of the samples.

$$Weight ( {x}_{k} ) = {{W}_{1} ( {z}_{k} \vert {x}_{k} )}_{{\_}_{Prediction Model}} * {{W}_{2} ( {x}_{k} \vert {x}_{k - 1} )}_{{\_}_{Mobility Model}} * {{W}_{old} ( {x}_{k - 1} )}_{{\_}_{History Model}} \qquad ( 2 )$$

Therefore, the particle filtering algorithm in FIG. 3 may comprise steps herein.

In step (a), each state in the state equation is selected.

In step (b), initial sampling is performed.

In step (c), weight prediction is performed by observation and calculation.

In step (d), resampling is performed according to the distribution of the samples.

By continuously repeating steps (b) to (d), a positioning method is completed as shown in FIG. 3.

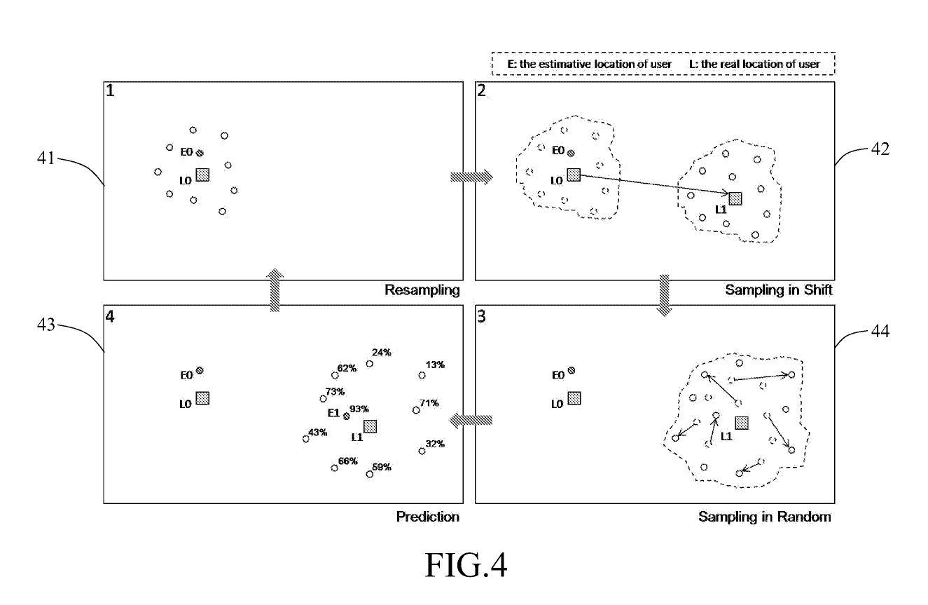

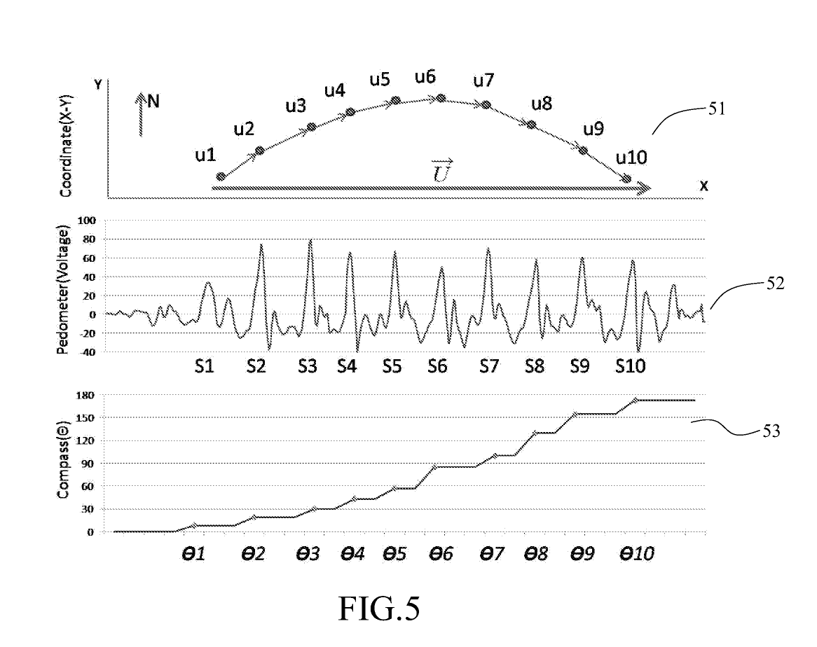

Practically, more detected data may lead to better performance by particle filtering algorithm. In fact, tracking algorithm is based on the conventional mobility model of the user to predict the user's current location. Since the motion behaviors and the locations of the user are strongly correlated, positioning by the motion behaviors of the user and conventional wireless signal intensity and particle filtering algorithm may result in better performance. Since the mobility model of the user is known, the particles can be observed directly based on the mobility model. FIG. 4 shows motion positioning using a particle filtering positioning system in one embodiment of this disclosure. Practically, in this disclosure, the sensors on the user can be used to detect a new detection value corresponding to the mobility model. Furthermore, the particle filters can be integrated with the system structure to improve the positioning precision.

Then, the current accumulative counts of steps (denoted by 31 in FIG. 3) and the compass angle (denoted by 32 in FIG. 3) can be converted by a converter) (denoted by 33 in FIG. 3), as described herein.

In FIG. 3, the input data of the converter 33 comprises the current accumulative counts of steps (denoted by 31 in FIG. 3) and compass angle (denoted by 32 in FIG. 3), while the output data comprises the motion vector (\vec{U}) 38.

The converter 33 is capable of processing the detected into another format. In other words, the changes in accumulative counts of steps and the angle of the user within a positioning range are integrated as a motion vector.

\vec{u} is defined as a motion vector representing each step of the user to comprise a motion length and a motion direction. The number of motion vectors \vec{u} within each positioning range is s.

\vec{U} denotes the total motion vector of the user within the positioning range. d is the distance of each steep of the user. The relation between \vec{U} and d can be expressed as Equation (3).

\vec{U}=\vec{u₁}+\vec{u₂}+ . . . +\vec{uₛ}″

\vec{uₛ}=d*cos(90°−θₛ)\vec{I}+d*sin(90°−θₛ)\vec{J} (3)

FIG. 5 shows motion information transfer using a motion converter in one embodiment of this disclosure, which includes three types of motions. The first type of motion information (denoted by 51 in FIG. 5) represents the user in a planar coordinate system with motion vectors on the X-Y plane and \vec{N} pointing the north pole of the compass. The second type of motion information (denoted by 52 in FIG. 5) represents the voltage signal of the pedometer of the user. In FIG. 5, the voltage signal is sinosoid and each cycle represents a step forward, which results in ten steps in total. The third type of motion information (denoted by 53 in FIG. 5) represents the compass angle. In this embodiment, when the pedometer detects a step, the compass angle is recorded. Therefore, the voltage signal of the pedometer shows that each step sᵢ corresponds to an angle θᵢ of the compass.

According to FIG. 5, the motion vector \vec{uₛ} of each step can be calculated based on the compass angle and the distance of each step. All the motion vectors within the positioning range can be summed up to obtain a total motion vector \vec{Uₛ} within the positioning range. In this manner, the accumulative counts of steps and the change in compass angles can be integrated into a single vector within each positioning range.

Therefore, information of the user's mobility model (denoted by 39 in FIG. 3) can be calculated by a converter, which will be described herein.

The input data of the user's mobility model (39 in FIG. 3) is the motion vector \vec{U} of the user, while the output data is the motion vector components ([X, Y]).

The user's mobility model is used for decomposing the total motion vector within a positioning range to obtain the motion vector components so that the particle filtering algorithm can perform coordinate conversion to simulate the user's motion.

The particle filtering algorithm can be expressed in Equation (5), wherein Pᵢ(t) indicates the position of the i^{th} particle at time t in X-Y coordinate; Ø is a random angle from X axis; α is a random variable with uniform distribution between 0≦α≦1; r is a pre-determined maximum random distance, r=2; \vec{N} and denotes the north pole direction of the compass.

$$\begin{matrix}{P}_{i} ( t ) = [ \begin{matrix}{X}_{i}^{t} \\ {Y}_{i}^{t}\end{matrix} ] \\ = {P}_{i} ( t - 1 ) + ‖ \vec{U} ‖ [ \begin{matrix}cos ( 90 ° - θ ) \\ sin ( 90 ° - θ )\end{matrix} ] + ( r \times a ) [ \begin{matrix}cos \\ sin \end{matrix} ] \\ = [ \begin{matrix}{X}_{i}^{t - 1} \\ {Y}_{i}^{t - 1}\end{matrix} ] + ‖ \vec{U} ‖ [ \begin{matrix}cos ( 90 ° - θ ) \\ sin ( 90 ° - θ )\end{matrix} ] + ( r \times a ) [ \begin{matrix}cos \\ sin \end{matrix} ]\end{matrix} \qquad ( 5 )$$

The location of the particle at time=(t−1) can be updated according to Equation (5) to obtain the location at time=t. The distribution of the locations of particles can be acquired by adding the X-axis and Y-Axis components of the corresponding total motion vector to the previous locations of the particles.

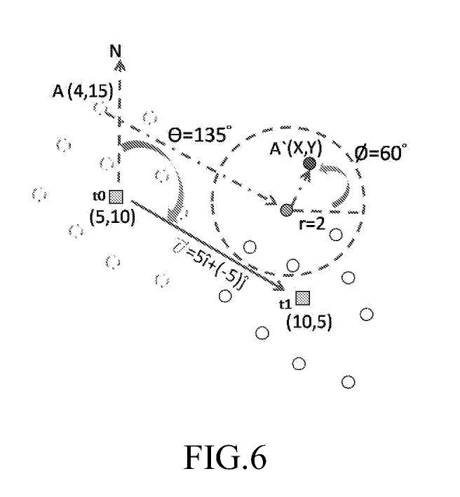

FIG. 6 shows calculation of motion coordinates of a user using a particle filtering positioning system in one embodiment of this disclosure. In FIG. 6, if the location of the user at time=(t−1) t₀(5, 10) and the location of the particle A(4,15) are shifted to t₁(10,5) and A′(X,Y) at time=t, the updated location of the particle is A′(X, Y).

As mentioned above, the positioning system in the present embodiment performs the positioning process based on the particle filtering algorithm in FIG. 3. The input data of the positioning system comprises wireless signal ([X,Y]) and user's motion vector (\vec{U}), while the output data is the estimated location E(t).[X,Y].

The positioning system operates based on particle filtering algorithm. By the use of externally detected data, the possible locations of the user can be sifted. These possible locations are referred to as particles. Each particle has a weight representing the probability that the user is at the location referred to as the particle. A particle filter comprises three modules. Each module operates in order according to the result of the previous module. A positioning result is generated when each of the three modules operates for one time.

In FIG. 3, these three modules are the resampling model 301, the sampling model 302 and the prediction model 303, respectively, as described herein.

The resampling model 301 omits particles with weights that are too low according to the previous (time=t−1) positioning process because these particles represent the locations at which the user is less likely to be at time=(t−1). The sampling model 302 performs coordinate conversion on the sifted particles according to the information of the user's mobility model to synchronize with the motion of the user so that the possible location of the user at time=t is calculated. The prediction model 303 calculates the weights of the particles according to the estimated locations of the particles so that wireless signals with higher weights can be acquired. The higher the weights, the higher probability the user is at the locations referred to as the particles.

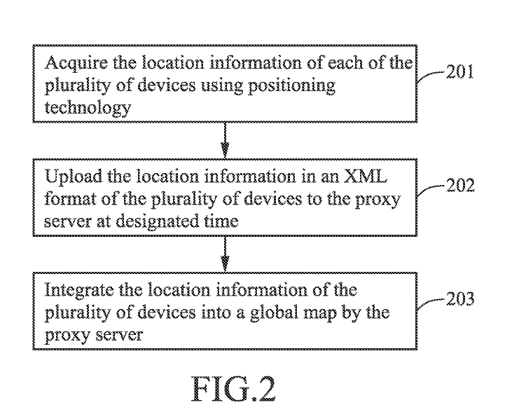

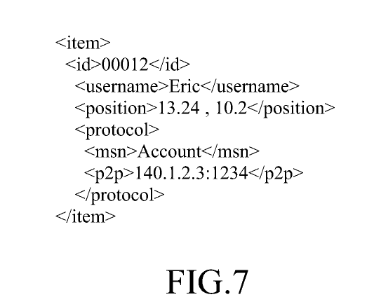

Step 202 in FIG. 2 describes in detail the flowchart for acquiring location information and synchronizing with the proxy server in step 102 in FIG. 1. The hand-held device uploads the positioning information and the protocols for the device to a proxy server after the positioning information at time=(t+1) is acquired. The uploaded data is in an XML format. FIG. 7 shows an XML format data for uploading information to a proxy server in one embodiment of this disclosure, wherein <item> denotes a hand-held device, <id> denotes the identification code of the device, <name> denotes the name of the device, <position> denotes the positioning information of the device, and <protocol> denotes the protocol for data transfer for the device. The foregoing definitions of the XML labels are only to exemplify one embodiment of this disclosure, and thus this disclosure is limited thereto. Any modification of this embodiment is within the scope of this disclosure.

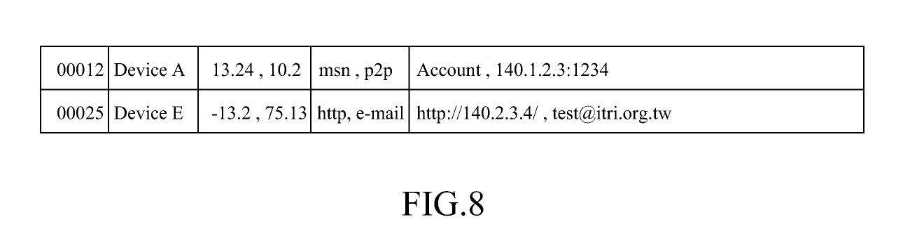

After the proxy server receives the uploaded data by the hand-held device, the device information is converted into a data stored in the database of a proxy server. FIG. 8 shows data for storing information in a database in one embodiment of this disclosure.

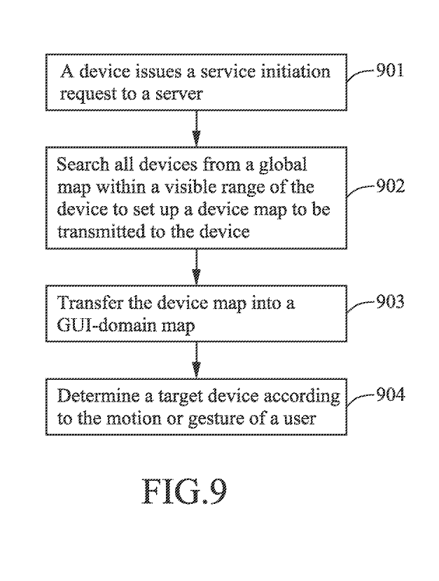

FIG. 9 shows a flowchart for issuing a service initiation request from a source device to a proxy server in one embodiment of this disclosure. The flowchart comprises steps herein.

In step 901, a device issues a service initiation request to a proxy server.

In step 902, the proxy server searches all devices from a global map within a visible range of the device to set up a device map to be transmitted to the device.

In step 903, the device converts the device map into a GUI-domain map.

In step 904: a target device is determined according to the motion or gesture of a user.

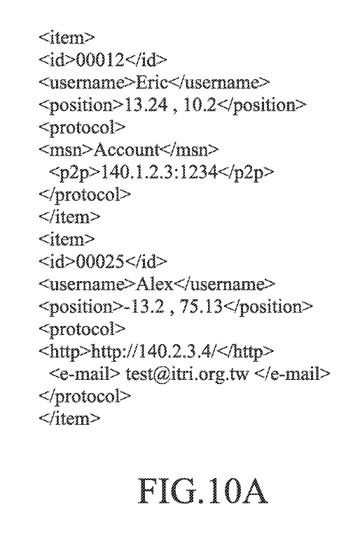

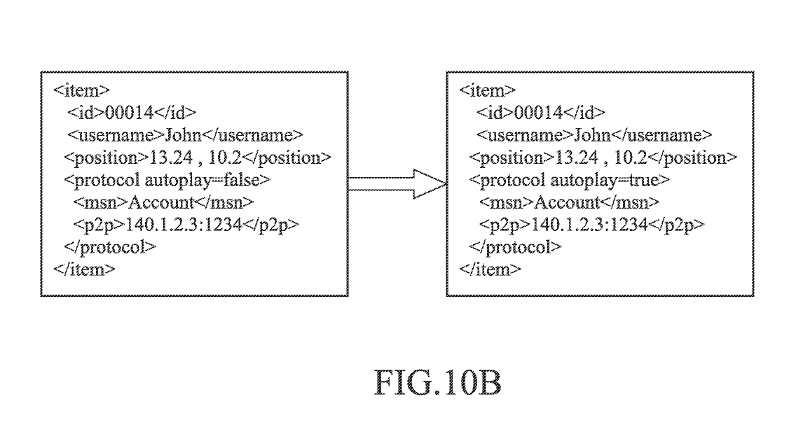

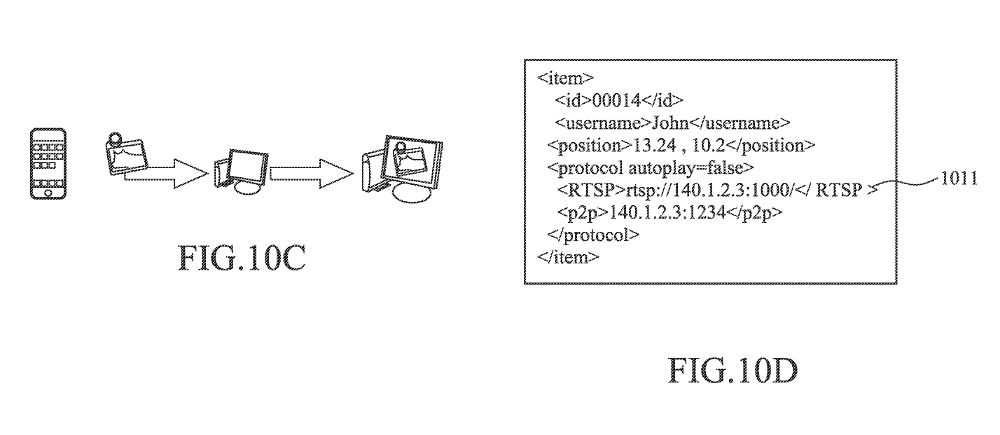

In one embodiment when a user is to transfer a file, the source device issues a service of data transfer request to a proxy server so that the proxy server searches all devices from a global map within a visible range of the source device to send the information of the devices (including locations and protocols) in an XML format to the source device. FIG. 10A shows an XML format data for sending information from a proxy server to a source device in one embodiment of this disclosure.

After the source device receives the XML format data from the proxy server, the source device converts the locations of the neighboring devices from the absolute coordinate system into the GUI coordinate system with the assistance of inertial elements (such as compasses, a gyroscopes, etc).

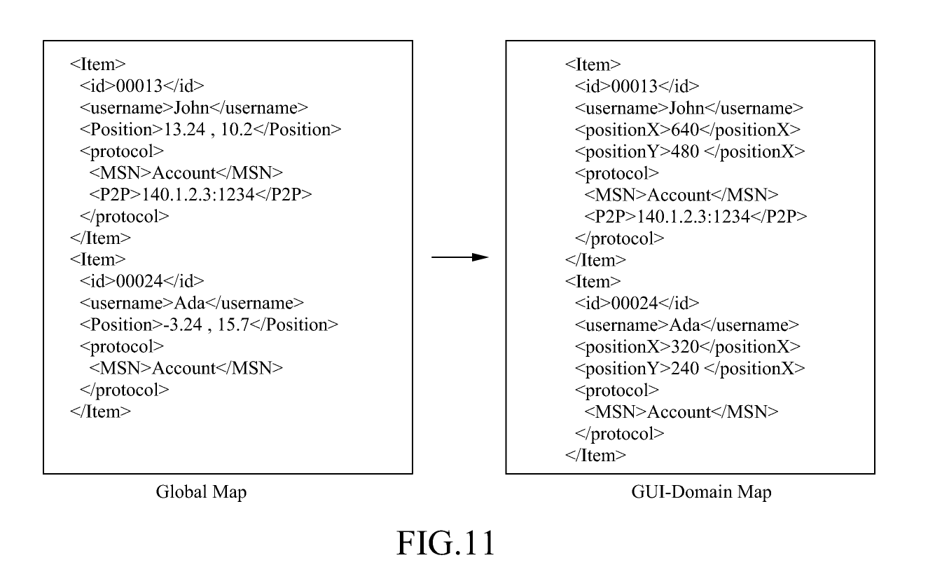

FIG. 11 shows an XML format data for converting global map information to GUI-domain map information in one embodiment of this disclosure.

Another embodiment employing XML format service initiation is shown in FIG. 10B. In FIG. 10B, the user sending a file set up the file transfer configuration, the receiving device will play the file automatically. When the autoplay function is turn on, the receiving device will modify the corresponding section in XML document accordingly, as shown in FIG. 10B, the value of <protocol autoplay> is changed from “false” to “true”. The operation flow diagram is shown in FIG. 10C. In Step 1 of FIG. 10C, the user, with gesture operation, “points” the target device to transfer a video file, and after receiving the file the target device automatically play the video, the schematic diagram is shown in Step 2 of FIG. 10C.

The file being transferred can be a stream file. In order to transfer a stream file, the user need to set up the file protocol as “stream”, the corresponding section in the XML file will be changed accordingly. As shown in FIG. 10D, in the XML document, <RTSP>(Real Time Streaming Protocol/RTSP)1011 is set up for transferring a stream file.

As shown in FIG. 11, the GUI-domain coordinates of the neighboring devices can be displayed in a 3D format on the display of the system. The shorter the distance to the source device is, the larger the displayed image of the device will be; and the longer the distance to the source device is, the smaller the displayed image of the device will be.

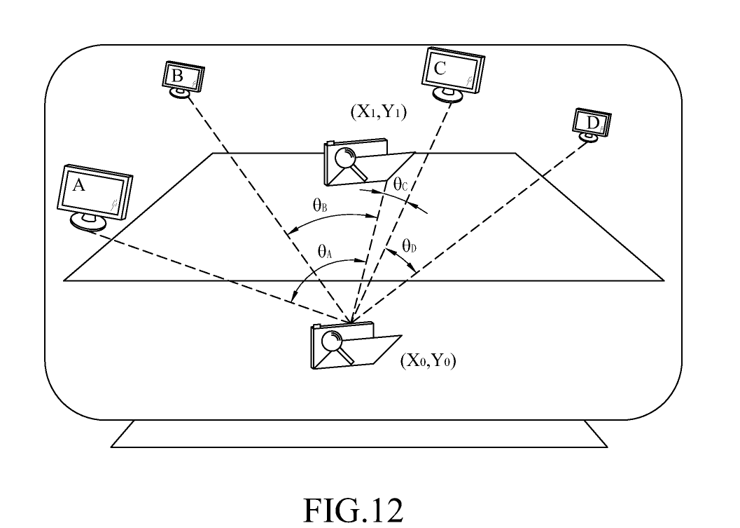

In the embodiment of transferring a file employing the service initiation of the present disclosure, since the relative locations of neighboring devices are displayed on the display, the user can assign a file to be transferred to one of the neighboring devices (i.e., a target device). The user selects one file to be transferred to the target device by two ways. The first one is by GUI selection, wherein the user directly drags the file and drops the file at an icon representing the target device or flings dragged file to the icon representing the target device. FIG. 12 is a schematic diagram for file transfer to a target device in a GUI domain in one embodiment of this disclosure. In FIG. 12, the original file location is (X₀,Y₀), the location after the file is dragged is (X₁,Y₁) and the file motion vector \vec{v}=(X₁−X₀, Y₁−Y₀). If the vector of the icons representing all the other devices at the original locations and in the GUI domain is (\vec{v}₀\vec{v}₁\vec{v}₂ . . . \vec{v}ᵢ), and the angle between \vec{v} and (\vec{v}₀\vec{v}₁\vec{v}₂ . . . \vec{v}ᵢ) is (θ₀θ₁θ₂ . . . θᵢ), the icon with the smallest θ angle value is the icon representing the target device. According to calculation, θ_{C}<θ_{D}<θ_{B}<θ_{A}. Therefore, the system determines that the user selects the device C as the target device. The other way is to select the target device using inertial elements, wherein the user uses the embedded inertial elements to fling the device to a substantial target device or the like. It is assumed that the directional vector acquired by the inertial elements is \vec{v}. If the directional vector of the locations of the source device and all the other devices is (\vec{v}₀\vec{v}₁\vec{v}₂ . . . \vec{v}ᵢ), and the angle between \vec{v} and (\vec{v}₀\vec{v}₁\vec{v}₂ . . . \vec{v}ᵢ) is (θ₀θ₁θ₂ . . . θᵢ) the icon with the smallest θ angle value is the icon representing the target device, as is described in FIG. 12.

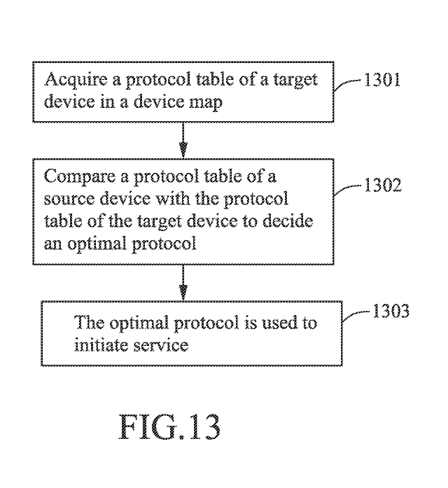

FIG. 13 shows a flowchart for transferring data and protocols between a target device and a source device in one embodiment of this disclosure. In FIG. 13, the flowchart at least comprises steps herein.

In step 1301, the source device acquires a protocol table of a target device in a device map.

In step 1302: a protocol table of a source device is compared with the protocol table of the target device to decide an optimal protocol.

In step 1303: the optimal protocol is used to initiate service.

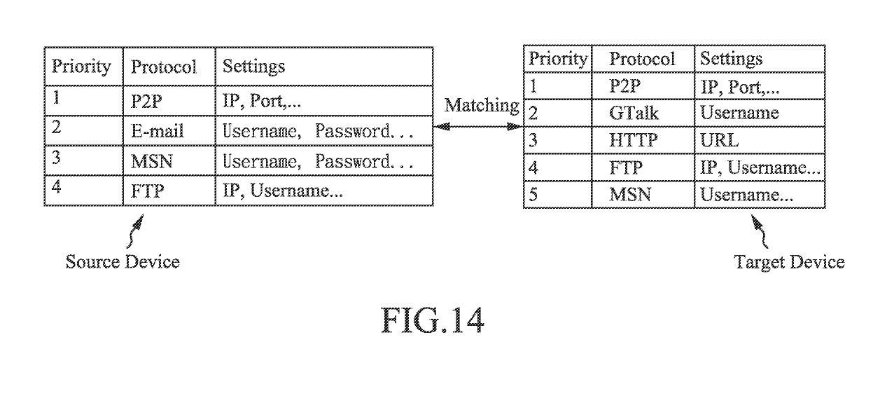

In these steps, firstly, the source device searches a protocol with the highest priority by matching its own protocol and the protocol of the target device. The device with fewer protocols available is searched. The protocols with higher priority are first compared until a protocol is determined when identical protocols are found. If there are no identical protocols found, GUI is used to inform the user that the target device fails to received files. FIG. 14 shows the contents of data and protocols transferred between a target device and a source device in one embodiment of this disclosure.

Accordingly, this disclosure provides a system and a method for vectoring service initiation based on sensor assisted positioning, using the location sensors built in hand-held devices with positioning technology to provide an instinctive 2-D or 3-D user-machine interface so that the user is able to transfer a file from a source device to a target device. Therefore, this disclosure is useful, novel and non-obvious.

Although this disclosure has been disclosed and illustrated with reference accelerometer to particular embodiments, the principles involved are susceptible for use in numerous other embodiments that will be apparent to persons skilled in the art. This disclosure is, therefore, to be limited only as indicated by the scope of the appended claims.

What is claimed is:

1. A method for service initiation based on sensor assisted positioning, comprising at least steps of:
(a) setting up an initial communication environment of a plurality of devices and determining a proxy server;
(b) acquiring location information of each of the plurality of devices using a positioning technology and synchronizing real-time location information of the plurality of devices and the proxy server;
(c) acquiring transferred positioning information of each of the plurality of devices through the proxy server by a source device of the plurality of devices, so that a user is able to use the transferred positioning information of each of the plurality of devices to assign a target device for service initiation; and
(d) invoking a service between the source service and the target device.

2. The method for service initiation as recited in claim 1, wherein step (b) comprises steps of:
(a) acquiring the location information of each of the plurality of devices using the positioning technology;
(b) uploading the location information in an XML format of the plurality of devices to the proxy server at designated time; and
(c) integrating the location information of the plurality of devices into a global map by the proxy server.

3. The method for service initiation as recited in claim 1, wherein the proxy server in step (a) provides information of map and topography of a building if the plurality of devices are disposed indoors and particle filtering algorithm and sensor assisted seamless hybrid positioning are used, and the initial communication environment of the plurality of devices in step (a) provide:
(a) a wireless networking based on WiFi, WiMAX or GSM so as communicate with the proxy server or the other devices;
(b) a global positioning system or a wireless triangulation positioning and pattern-matching positioning system and a sensor feedback element capable of sensing current inertial trajectories and behaviors and transmitting the current inertial trajectories and behaviors to the positioning system; and
(c) protocols for MSN, HTTP and P2P and settings for the protocols, the settings comprising usernames, passwords and IP's so that the plurality of devices are capable of invoking service.

4. The method for service initiation as recited in claim 1, wherein the positioning technology in step (b) comprises global positioning based on triangulation positioning.

5. The method for service initiation as recited in claim 1, wherein the positioning technology in step (b) comprises WiFi, WiMAX, GSM, ZigBee or Bluetooth positioning based on signal strength matching positioning.

6. The method for service initiation as recited in claim 1, wherein the location information of each of the plurality of devices in step (b) is updated for a fixed time period or a variable time period according to the speed of the user, wherein the time period is shorter when the speed is higher and the time period is longer when the speed is lower.

7. The method for service initiation as recited in claim 1, wherein said service initiation can be data transfer, game initiation, media download, media streaming initiation or house application.

8. The method for service initiation as recited in claim 1, wherein the transferred positioning information of the plurality of devices is displayed in a 3D or 2D format on a display of each of the plurality of devices.

9. The method for service initiation as recited in claim 1, wherein the target device is assigned by the user using a motion or a gesture.

10. The method for service initiation as recited in claim 1, wherein the target device is assigned by the user on a display of each of the plurality of devices.

11. The method for service initiation as recited in claim 1, wherein the proxy server is one selected from the source device, the target device, a fixed device in a local area network and a communication device at a far end.

12. The method for service initiation as recited in claim 1, wherein the file is transferred according to protocols comprising HTTP, FTP, E-mail, MSN, Google Talk, Skype or P2P based protocols.

13. The method for service initiation as recited in claim 1, wherein the file is transferred with an optimal protocol based on greedy algorithm.

14. The method for service initiation as recited in claim 1, wherein the source device can be a fix device or a mobile device.

15. The method for service initiation as recited in claim 1, wherein the target device can be a fix device or a mobile device.

16. The method for service initiation as recited in claim 1, when the service is transferring a file, wherein the target device can be configured with a preview function to display the information of the file being transferred, by a user's drag-and-drop gesture, from the source target.

17. The method for service initiation as recited in claim 15, wherein the information of the file can be the file name, file type, file size or the like.

18. The method for service initiation as recited in claim 1, when the service is transferring a file, wherein the target device can be configured with a autoplay function to automatically play the stream files or the like being transferred, by a user's drag-and-drop gesture, from the source target.

19. The method for service initiation as recited in claim 2, wherein the XML format comprises an identification code, a device name, positioning information and a protocol of each of the plurality of devices.

20. The method for service initiation as recited in claim 2, when the service is transferring a file, wherein the XML format can comprise an autoplay section to invoke the autoplay function in the target device to automatically play the stream file being transferred, by a user's drag-and-drop gesture, from the source device.

21. The method for service initiation as recited in claim 2, wherein the file protocol section of the XML format can be configured as “stream” to transfer a stream file from the source device to the target device by a user's drag-and-drop gesture.

22. The method for service initiation as recited in claim 8, wherein an elevation sensor is used to change displayed patterns when the transferred positioning information is displayed in the 3D format.

23. The method for service initiation as recited in claim 8, wherein the transferred positioning information further comprises target device information including user information for the user to confirm.

24. The method for service initiation as recited in claim 9, wherein the motion or the gesture is identified by an accelerometer, a compass sensor, an angular accelerometer or a combination thereof.

25. The method for service initiation as recited in claim 10, wherein the display is a non-touch display with a mouse or a keyboard.

26. The method for service initiation as recited in claim 10, wherein the display is a touch display.

27. A system for service initiation based on sensor assisted positioning, comprising:
at least one source device capable of invoking service, when the system needs a proxy server and no such proxy server exists, said source device can be a proxy server being capable of real-time receiving and transferring real-time location information of each of a plurality of devices;
at least one target device capable of receiving the service, when the system needs a proxy server and no such proxy server exists, said target device can be a proxy server being capable of real-time receiving and transferring real-time location information of each of a plurality of devices; and
wherein an initial communication environment of the source device, the proxy server and the target device is initialized, the plurality of devices use positioning technology to acquire the location information of each of the plurality of devices and real-time location information of the plurality of devices and the proxy server is synchronized, the source device acquires transferred positioning information of each of the plurality of devices through the proxy server so that a user is able to use the transferred positioning information of each of the plurality of devices to invoke service between the source device and the target device.

28. The system for service initiation as recited in claim 27, said service initiation can be data transfer, game initiation, media download, media streaming initiation or house application.

29. The system for service initiation as recited in claim 27, wherein the step of acquiring the location information and synchronizing the real-time location information comprises steps of:
acquiring the location information of each of the plurality of devices using positioning technology;
uploading the location information in an XML format of the plurality of devices to the proxy server at designated time; and
integrating the location information of the plurality of devices into a global map by the proxy server.

30. The system for service initiation as recited in claim 27, wherein the proxy server provides information of map and topography of a building if the plurality of devices are disposed indoors and particle filtering algorithm and sensor assisted seamless hybrid positioning are used, and the initial communication environment of the plurality of devices provide:
wireless networking based on WiFi, WiMAX or GSM so as communicate with the proxy server or the other devices;
a global positioning system or a wireless triangulation positioning and pattern-matching positioning system and a sensor feedback element capable of sensing current inertial trajectories and behaviors and transmitting the current inertial trajectories and behaviors to the positioning system; and
protocols for MSN, HTTP and P2P and settings for the protocols, the settings comprising usernames, passwords and IP's so that the plurality of devices are capable of transferring files.

31. The system for service initiation as recited in claim 27, wherein the source device can be a fix device or a mobile device.

32. The system for service initiation as recited in claim 27, wherein the target device can be a fix device or a mobile device.

33. The system for service initiation as recited in claim 27, when the service is transferring a file, wherein the target device can be configured with a preview function to display the information of the file being transferred, by a user's drag-and-drop gesture, from the source target.

34. The system for service initiation as recited in claim 32, wherein the information of the file can be the file name, file type, file size or the like.

35. The system for service initiation as recited in claim 27, when the service is transferring a file, wherein the target device can be configured with a autoplay function to automatically play the stream files or the like being transferred, by a user's drag-and-drop gesture, from the source target.

36. The system for service initiation as recited in claim 27, wherein the positioning technology comprises global positioning based on triangulation positioning.

37. The system for service initiation as recited in claim 27, wherein the positioning technology comprises WiFi, WiMAX, GSM, ZigBee or Bluetooth positioning based on signal strength matching positioning.

38. The system for service initiation as recited in claim 27, wherein the location information of each of the plurality of devices is updated for a fixed time period or a variable time period according to the speed of the user, wherein the time period is shorter when the speed is higher and the time period is longer when the speed is lower.

39. The system for service initiation as recited in claim 27, wherein the transferred positioning information of the plurality of devices is displayed in a 3D or 2D format on a display of each of the plurality of devices.

40. The system for service initiation as recited in claim 27, wherein the target device is assigned by the user using a motion or a gesture.

41. The system for service initiation as recited in claim 27, wherein the target device is assigned by the user on a display of each of the plurality of devices.

42. The system for service initiation as recited in claim 27, wherein the proxy server is one selected from the source device, the target device, a fixed device in a local area network and a communication device at a far end.

43. The system for service initiation as recited in claim 27, wherein the file is transferred according to protocols comprising HTTP, FTP, E-mail, MSN, Google Talk, Skype or P2P based protocols.

44. The system for service initiation as recited in claim 27, wherein the service is invoked with an optimal protocol based on greedy algorithm.

45. The system for service initiation as recited in claim 29, wherein the XML format comprises an identification code, a device name, positioning information and a protocol of each of the plurality of devices.

46. The system for service initiation as recited in claim 29, when the service is transferring a file, wherein the XML format can comprise an autoplay section to invoke the autoplay function in the target device to automatically play the stream file being transferred, by a user's drag-and-drop gesture, from the source device.

47. The method for service initiation as recited in claim 29, when the service is transferring a file, wherein the file protocol section of the XML format can be configured as “stream” to transfer a stream file from the source device to the target device by a user's drag-and-drop gesture.

48. The system for service initiation as recited in claim 39, wherein an elevation sensor is used to change displayed patterns when the transferred positioning information is displayed in the 3D format.

49. The system for service initiation as recited in claim 39, wherein the transferred positioning information further comprises target device information including user information for the user to confirm.

50. The system for service initiation as recited in claim 40, wherein the motion or the gesture is identified by an accelerometer, a compass sensor, an angular accelerometer or a combination thereof.

51. The system for service initiation as recited in claim 41, wherein the display is a non-touch display with a mouse or a keyboard.

52. The system for service initiation as recited in claim 41, wherein the display is a touch display.
